(19) United States
(12) Patent Application Publication
(10) Pub. No.: US 2008/0285781 A1
(43) Pub. Date: Nov. 20, 2008

(54) Signal Processing System, for Example Sound Signal Processing System or a Hearing Aid Device

(75) Inventors: Steven Aerts, Leuven (BE); John Garas, Den Haag (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,994

(22) PCT Filed: Nov. 14, 2006
(86) PCT No.: PCT/IB2006/054238

§ 371 Date: May 16, 2008

(30) Foreign Application Priority Data
Nov. 18, 2005 (EP) 05110912.2

(51) Int. Cl. H04R 25/00

(52) U.S. Cl. 381/312

(57) ABSTRACT

Signal processing system (1), for example a sound signal processing system or a hearing aid device, comprising: —at least one signal input (5); —at least one signal output (7), —at least one signal processor (3), the signal processor (3) being configured to process signals received from the signal input (5), and to feed processed signals to the signal output (7) via at least one processor output (17); —at least one by-pass system (9, 11) configured to fade-out and/or decouple the processor output (17) at least partly from the at least one signal output (7), and to couple and/or fade-in the at least one signal input (5) at least partly to the at least one signal output (7) during the mentioned fading out and/or decoupling of the processor output (17). The invention also relates to a signal processing method.

The invention relates to a signal processing system and a signal processing method. The invention also relates to a use of a signal processing system.

Signal processing systems are known in various forms and types. Known signal-processing systems include one or more adjustable signal processors.

An example of a signal processing system is an adjustable or programmable hearing aid device. A hearing aid device can be provided to compensate for the hearing loss of the user of the device.

Since the hearing loss is different from one user to another, one or more device parameters (such as filter coefficients) usually need to be adjusted for each individual user. Modern hearing aid devices also include advanced functionalities (also called functional blocks), such as dynamic range compression and beam forming. The parameters and coefficients of such functional blocks as well as the characteristics of the hearing loss compensation usually need to be changed to meet the user needs. Changing the device parameters from one setting to the other may be done by the audiologist (during a fitting session) or by the user himself during normal operation.

Switching the device parameters from one setting to another may cause uncontrolled high amplitude spikes at the hearing aid speaker. In case the speaker is directly placed into the user's ear canal, those spikes may cause severe damage to the user's hearing if no precautions are taken.

The European patent EP 0 341 903 B1 relates to a hearing aid programming interface and method. According to this patent, programmable hearing aids amplification functions are automatically muted during loading of new program data, to prevent operation of the hearing aid when it is in an indeterminate state, and to prevent any possibly injurious sounds being generated during program selection and reprogramming. A problem of this solution is, that it makes the fitting procedure relatively long, particularly when many settings have to be tried and the user is asked to choose the best setting. Thus, this solution may cause the user to forget what the previous setting output was, and makes it more difficult for the user to take a right decision, therefore making the fitting inaccurate.

An other known method involves smooth parameter transition; see for example EP 1 513 371. In such a method, to smoothly carry out audio processing parameters transition from one working set to a new set without audible artifacts, the parameters in question are changed in small steps from their current values to their new values. This technique is commonly used in digital audio systems (including consumer electronics), for instance, to adjust the master volume. In such equipment, the change rate is usually fixed, (for instance to 24 dB per second) which determines the step size by which the variable in question (in this case, the volume) can be incremented or decremented every sample period. Applying this procedure forces the variable to take a pre-specified time interval to complete the user requested change in the system setting.

The parameter transition procedure may be acceptable when switching a few number of parameters at a time. As the number of parameters increases, however, changing all variables in small steps is not practical anymore.

A goal of the present invention is to improve the signal processing system and signal processing method. Also, an aspect of the invention aims to prevent problems associated with adjusting a signal processor, for example problems associated with switching audio parameters in a hearing aid, from one set of values to another.

In an aspect of the invention, there is provided a signal processing system for example a sound signal processing system or a hearing aid device, comprising:

at least one signal input;

at least one signal output;

at least one adjustable signal processor, the signal processor being configured to process signals received from the signal input, and to feed processed signals to the signal output via at least one processor output;

at least one by-pass system configured to fade-out and/or decouple the processor output at least partly from the at least one signal output, and to couple and/or fade-in the at least one signal input at least partly to the at least one signal output during the mentioned fading out and/or decoupling of the processor output.

In this way, problems associated with adjusting a signal processor can be prevented in a simple and efficient manner. Particularly, the adjusting or switching of one or more processor parameters can be performed swiftly, without harming or annoying the user of the system. As an example, a large number of parameters can be switched safely and at the same time. In a further embodiment, for example, the by-pass system can establish that the signal output is never (fully) discontinued during a safe and quick switching of processing system parameters. As an example, in case the system is embodied in a hearing aid device, possibly injurious sounds being generated during program selection and reprogramming can be prevented, and a device fitting procedure can still be comfortable, short and, thus, user-friendly.

In a further embodiment, the present invention allows hearing aid parameters to be safely and quickly changed while a user is wearing a hearing aid device, preferably without substantially discontinuing the sound, therefore, improving fitting procedure reliability, and improving the device to user feedback.

An other aspect of the invention provides a signal processing method, for example a sound signal processing method or a hearing aid method, for example a method utilizing a system according to the invention, the method comprising:

providing at least one signal input;

providing at least one signal output;

providing at least one adjustable signal processor, the signal processor being configured to process signals received from the input, and to feed processed signals to at least one processor output;

wherein the at least one processor output is faded-out and/or decoupled at least partly from the at least one signal output during a certain by-pass period, wherein the at least one signal input is coupled and/or faded-in at least partly to the at least one signal output during the mentioned by-pass period.

This method can provide the above-mentioned advantages.

For example, the method can be or include a method for hearing aid parameters switching.

Also, the invention provides a use of a system according to the invention, for example during a hearing aid method and/or a method to compensate a hearing loss, wherein the by-pass system fades-out and/or decoupled the processor output at least partly from the at least one signal output at a beginning of a signal processor adjusting phase, wherein the by-pass system couples and/or fades-in the at least one signal input at least partly to the at least one signal output at the beginning of a signal processor adjusting phase. As an example, the by-pass system can be configured such that a signal strength loss at the signal output due to the decoupling or fading out of the processor output, is partly or substantially compensated or counteracted by the coupling or fading-in of the at least one signal input to the output. This use can also provide the above-mentioned advantages. For example, during use, the signal strength at the signal output can be kept substantially at the same level during the decoupling or fading out of the processor output.

Further advantageous embodiments of the invention are described in the dependent claims. These and other aspects of the invention will be apparent from and elucidated with reference to the embodiments described hereinafter.

The invention will now be described in more detail on the basis of exemplary embodiments shown in the accompanying drawing. Therein shows:

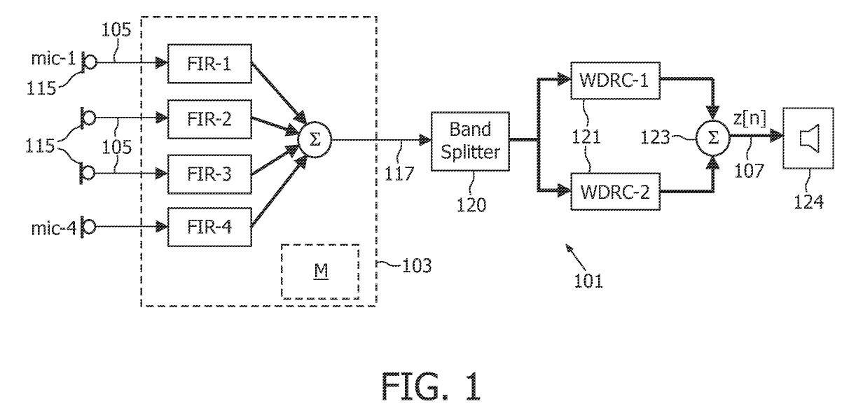

FIG. 1 a diagram of an embodiment of a hearing aid system;

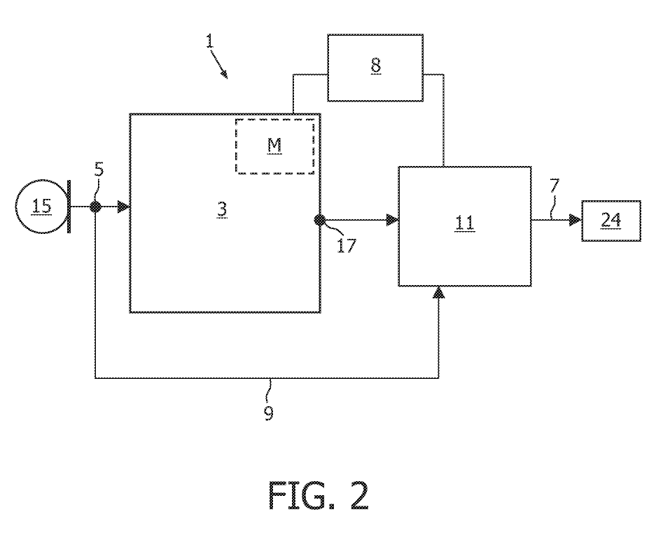

FIG. 2 a diagram of a system according to an embodiment of the invention;

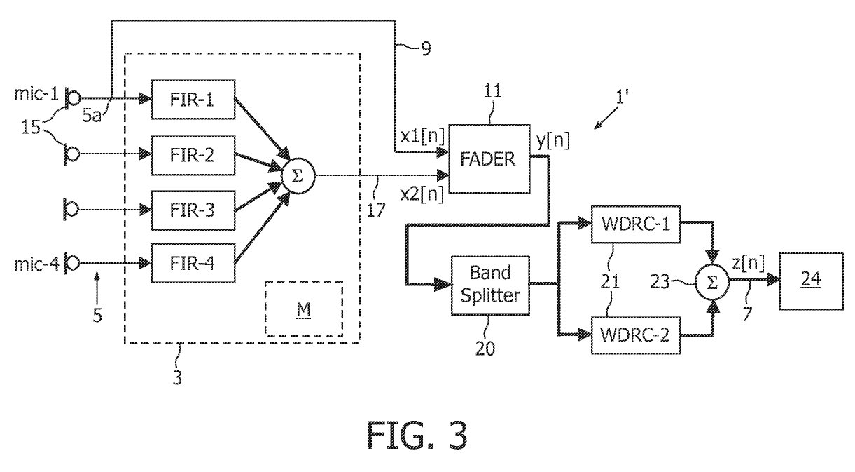

FIG. 3 a diagram of a system according to a second embodiment of the invention; and

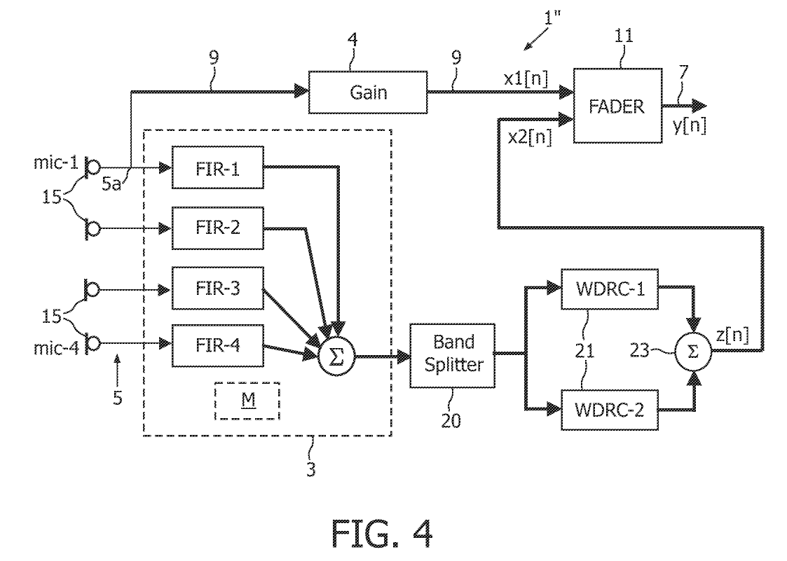

FIG. 4 a diagram of a system according to a third embodiment of the invention.

In the present application, corresponding or similar features are indicated using corresponding or similar reference signs.

A hearing aid device is often required to re-initialize one or more audio processing algorithms with a new set of parameters. This can be necessary for instance during fitting, or when the user wishes to change the hearing aid program. Usually, it is necessary to perform parameters switching while the user is wearing the hearing aid. In prior art devices, switching from one working set of parameters to a new set without taking any precautions results in audible clicks at the hearing aid output. The magnitude and duration of the clicks depend on the parameters to be changed and the difference between the current and new values. Since it is not possible to control those factors, an unpredictable output may result. This might cause high level acoustic pulses to be inserted at the user's ear canals, causing uncomfortable feeling, and may cause further damage to the user ears.

FIG. 1 shows a diagram of part of a directional hearing aid device 101. The hearing aid device 101 is provided with a first signal processor 103, which is coupled to a number (four in the present embodiment) signal inputs 105. For example, the first signal processor 103 can be a microphone array beam former processor. A number of respective sound detectors 115, particularly a microphone array, are coupled to the signal inputs 105, to provide sound related electric signals to the first signal processor 103. The hearing aid system also includes a main signal output 107. An output 117 of the first signal processor 103 (also called processor output) is coupled to the main signal output 107 of the system 101, via a number of further signal processing units 120, 121, 123, for example via a band splitter 120, Wide Dynamic Range Compression (WDRC) algorithm units 121, and a signal combiner 123. Such further units 120, 121, 123 may also be referred to as signal processors. A number of the signal processors 103, 120, 121, 123 can be separate components, can be integrated with each other or be provided in an other way, as will be clear to the skilled person.

For example, ‘downstream’, the signal output 107 can be coupled to one or more sound transducers or electro acoustic transducers 124, for example a speaker or receiver, which can be fed by electric signals from the signal output 107 to generate sound. If desired, the sound transducer 124 can independently include an end-stage signal attenuation device, gain device and/or signal processor, separate from the signal processing means 103, 120, 121, 123 of the signal processing system 101, for example to provide a final and/or non-adjustable attenuation or gain (i.e. increasing or decreasing) of sound signals to generate sound from the signals.

In the present embodiment of FIG. 1, sound signals can be processed substantially digitally. Alternatively, a hearing aid device or signal processing system can be configured to process analogue sound signals, or to provide a combination of digital and analogue processing.

An audio processing chain in the directional hearing aid device of FIG. 1 can be as follows. Speech signals can be captured by the microphones 115 (for example digitally, by sampling), and can be processed by several signal-processing algorithms, as shown in FIG. 1. First, the microphone signals can be filtered through a set of Finite Impulse Response Filters (FIR) of the first signal processor 103, which filters FIR implement both Hearing Loss Compensation (HLC) and microphone array Beam Former functionalities. A resulting set of filtered signals can be summed together to form a Beam Former output signal of the first signal processor 103, which output signal is provided on the processor output 117 by the first signal processor 103. This Beam Former output signal can then be split into separate frequency bands by the Band-Splitter Filter 120. Each of the frequency bands, provided by this filter 120, is then processed through a Wide Dynamic Range Compression (WDRC) algorithm by the respective WDRC-1 and WDRC-2 units 121. The audio output signals, resulting from the last-mentioned WDRC blocks 121, are then summed by the signal combiner 123, and sent via the system main output 107 to the hearing aid receiver 124.

In the directional hearing aid device 101 shown in FIG. 1, for example, each of those audio processing blocks of the first signal processor 103 (Beam Former), the Band-Splitter Filter (BSF) 120, and the Wide Dynamic Range Compressors (WDRC) 121 can have its own set of parameters, where any arbitrary combination of all parameters is allowed. For example, the depicted signal processing system 101 can be provided with one or more suitable memories M to store the parameters (one such memory M, of the first processor 3, is schematically depicted). As a non-limitative example, in one possible implementation, the Beam Former 103 has four sets of 32 complex (frequency domain) coefficients. Then, the Band-Splitter Filter 120 can have 6 filter coefficients (second order IIR filter) that can be selected out of 16 possible sets. Also, as an example, each of the Wide Dynamic Range Compressors units 121 can have 9 parameters. Each parameter can be selected independently from a set of possible values ranging from 16 to 90 settings. This sums to a large number of permutations, making the device parameters switching uncontrollable, and leading to an unpredictable output at switching times.

In the embodiment of FIG. 101, a master volume parameter of a hearing aid device 101 will be taken as an example. For example, the volume parameter in a 16-bit hearing aid can assume any value from 0 dB (full scale) to −90 dB (muted output). Suppose the user wishes to switch from a current user program with volume setting of −20 dB to a new program with a volume setting of 0 dB. Abruptly switching to the new user program will then cause a volume level discontinuity of +20 dB, which will propagate to the speaker 124 where it is converted to an acoustic pulse played in the user's ear canal. To avoid such uncomfortable and possibly damaging acoustic pulses, it is desired to take precautions, such that transitions between current and new values of audio processing parameters occur smoothly.

One obvious solution to this problem is to reduce the signal amplitude at the main output 107 in order to mitigate the impact of high-pressure clicks. This can be done for instance by reducing a device's master volume. Reducing the master volume to its minimum (−90 dB for instance) makes the acoustic clicks not audible at the receiver 124 any more. However, muting the output 107 makes a hearing aid fitting procedure (where many settings have to be tried and the user is asked to choose the best setting) very lengthy and inaccurate. Therefore, a different solution than muting would be certainly preferred.

Besides, in the embodiment of FIG. 1, changing all variables in small steps utilizing a mentioned parameter transition method is not practical. For example, applying such approach when switching the Beam Former coefficients would be problematic, since a typical Beam Former implementation can require 32×4×2=256 parameters (four sets of 32 complex frequency domain coefficients each) that must be smoothly updated in such a case. Updating the 256 coefficients at the same time using small steps puts a huge computation load on the hearing aid processor. The calculated load required to perform the transition will generally exceed the capacity of the ultra low power processors typically used in hearing aid devices by several times.

FIG. 2 depicts a system 1 according to a first embodiment of the invention. For example, the system 1 can be a sound (signal) processing system or a hearing aid device, including or being coupled to one or more sound transducers 24 The system of FIG. 2 comprises a signal input 5, a signal output 7, and an adjustable signal processor 3. For example, the signal output 7 can be a main signal output, or a different signal output such as a sub-output. The signal processor 3 is configured to process signals received from the input 5, and to feed processed signals towards the output 7 via at least one processor output 17. In the present embodiment, the mentioned system output 7 can be coupled, for example, to a mentioned sound transducer 24. The system output 7 can also be coupled to other means, for example to an input of a further signal processor and/or other device.

In the embodiment of FIG. 2, the system 1 is provided with a by-pass system 9, 11 which is configured to decouple and/or fade-out the processor output 17 at least partly from the at least one signal output 7, and to couple or fade-in the at least one signal input 5 at least partly and directly to the at least one signal output 7, particularly during the mentioned decoupling and/or fading out of the processor output 17. By directly coupling and/or fading in the signal input 5 to the output 7, the at least one signal processor 3 is by-passed, or, in other words, signals received at the signal input 5 can reach the signal output 7 without traversing the signal processor 3 (or at least a signal processing part FIR thereof). In this way, a safe parameter switching of processor parameters can be obtained, wherein problems associated with muting of the system output 7 can be avoided. Particularly, the by-pass system can be configured to substantially fade out the processor output 17 during the coupling or fading in of the signal input 5 to the signal output 7.

For example, the by-pass system can include at least one signal controller 11, the signal controller 11 being arranged to control coupling/decoupling of the at least one processor output 17 to the mentioned signal output 7, and to control coupling/decoupling of the signal input 5 to the mentioned signal output 7. The signal controller 11 can be configured in various ways, depending for example on the type of signal to be controlled. The controller 11 can be a hardware-type and/or software-based controller 11. The controller 11 can be part of the mentioned signal processor 3, be integrated therewith, or be a separate part of the system 1. Preferably, the signal controller 11 simply includes one or more faders to gradually fade out the processor output 17 during a certain predetermined fading time-period. Also, preferably, for example, one or more faders of the controller 11 can be configured to fade-in the signal input 5 of the system 1 directly into the signal output 7 of the system 1, during the fading out of the processor output 17, for example during the fading time-period. A mentioned fader of the signal controller 11 can be configured in various ways. For example, the fader object used in this procedure can be a simple first order filter with two inputs and one output, it can be an electronic fader and/or it can be a different fader.

In the embodiment of FIG. 2, the signal controller 11 is arranged directly between the signal processor 3 and a main signal output 7. Alternatively, as is shown in FIG. 3, a signal controller can be coupled indirectly to a main signal output 7, for example via one or more further signal processing units 20, 21, 23.

Also, in the embodiment of FIG. 2, the signal controller 11 is arranged directly between the signal input 3 and a signal output 7. Alternatively, as is shown in FIG. 4, a signal controller can be coupled indirectly to a signal input 3, for example via one or more other system components, for example a signal gain (see below).

As shown in FIG. 2, the by-pass system can also include at least one signal by-pass line 9, the by-pass line 9 being arranged to couple the at least one signal input 5 to the signal controller 11, the signal controller 11 being arranged to control coupling of the by-pass line 9 to the mentioned signal output 7. Such a by-pass line 9 can be constructed in various ways, as will be clear to the skilled person. For example, a by-pass line can include suitable signal communication means, electric wiring, a wireless connection and/or other means, depending for example on the type of signal to be fed from the input 5 to the output 7. Also, the by-pass line 9 can be part of the mentioned signal controller 11, be integrated therewith, or be a separate part of the system 1, depending for example on the arrangement and implementation of various system parts. As an example, a number of the system parts 3, 9, 11 can be integrated with each other, for example in an integrated circuit (IC) or a similar structure.

In a further aspect, one or more signal processing parameters of the signal processor 3 are adjustable, wherein the at least one by-pass system 9, 11 is configured to decouple and/or fade-out the processor output 17 at least partly from the at least one main signal output 7 before one or more signal processing parameters are being adjusted. The at least one by-pass system 9, 11 can also be configured to couple and/or fade-in the processor output 17 to the at least one signal output 7 after one or more signal processing parameters have been adjusted.

Besides, as shown in FIG. 2, a signal processor adjusting system 8 can be provided, the adjusting system 8 being configured for adjusting the signal processor 3, for example to set one or more processor parameters. As an example, such parameters can be stored in a memory M of the processor 3. Such an adjusting system 8 can also be constructed in various ways. For example, such an adjusting system 8 can be arranged to be operated, for example, by a user, and/or by an operator, for adjusting the system 1 to meet a desired signal processing performance. The adjusting system 8 may be manually controllable, and/or electronically, for example by external computer control, and/or in a different way. The adjusting system 8 can be a separate system component and/or can be at least partly integrated with one or more other component parts, for example with the signal processor 3, and/or with the signal by-pass controller 11. Besides, as an example, the by-pass system 9, 11 can be controllable by and/of via the signal processor adjusting system 8, particularly such that the mentioned decoupling or fading out of the processor output 17 is automatically performed at a start of the adjusting of the signal processor 3.

Besides, the at least one by-pass system can be configured to decouple and/or fade-out the at least one signal input 5 from the at least one signal output 7 after one or more signal processing parameters have been adjusted, for example at the end of a signal processor adjusting phase.

During use of the embodiment of FIG. 2, for example during a hearing aid method and/or a method to compensate a hearing loss, the signal processor 3 can process signals received from the system input 5, such as sound related signals (also called sound signals), which signals can be generated by the microphone 15.

In case adjusting of the signal processor 3 is to be carried out, the adjusting system 8 can, for example, be activated, operated and/or controlled, depending on the configuration of the adjusting system 8. In an embodiment, the adjusting system 8 can cooperate with the by-pass system 9, 11, to bring the processing system 1 in a certain by-pass period wherein the signal processor 3 is being by-passed. For example, the by-pass period can include a start of a processor-adjusting phase, a subsequent main adjusting phase and an end of the adjusting phase.

At the start of the adjusting phase, for example when the adjusting system 8 is activated, operated and/or controlled and before one or more signal processing parameters are adjusted (i.e., before the main adjusting phase), the controller (or fader) 11 can fade-out the signal processor output 17 within a relatively short time frame, for example within a second or part of a second. The fading can involve a partial fading, but preferably involves a substantial fading-out and/or decoupling of the processor output 17.

At the same time, the controller 11 can fade-in (or couple) the system signal input 5, which the controller 11 receives from the by-pass line 9, directly into the system output 7. For example, the controller 11 can feed the signal input 5 directly to the system output, preferably using such a fading-in process, such that substantially no or only a small and gradual variation of signal strength occurs at the system signal output 7. In this case, the fading can also involve a partial fading, but can also involve a substantial fading-in of the system signal input 5. The mentioned fading-in is preferably performed such that a signal strength loss at the signal output 7 due to the decoupling or fading out of the processor output 17, can be substantially compensate for, or counteracted.

Preferably, a mentioned fading out of the processor output 17 also involves a substantial decoupling of the processor output 17 from the system output 7, such that any spikes in that processor signal cannot reach the system output 7 after the fading-out process.

Preferably, a mentioned fading (both fading-in and fading-out) involves a substantially swift ramping of a respective signal. The fading can be a digitally fading process, or an analogue fading process.

As an example, in the above, the signal controller 11 can be controlled by the adjusting system 8, and/or be activated thereby, to start the mentioned fading actions.

Next, during a second part of the by-pass period (the mentioned main adjusting phase), one or more signal processing parameters of the signal processor 3 can be adjusted safely by the adjusting system 8. Herein, preferably all processing parameters, stored in a processor memory M, are adjusted in one step. During this main adjusting phase, the by-pass system 9, 11 couples the signal input 5 substantially directly to the output 7, and can feed signals directly from the system input 5 to the system output 7, thus by-passing the signal processor 3. In this way, a certain natural level of signal strength can be upheld at the system output 7 during the start and subsequent main phase of the adjusting of the processor 3.

In the embodiment of FIG. 2, unprocessed signals (i.e., signals not being processed by the processor 3) can be fed substantially directly from the signal input 5 to the signal output 7 during the main phase of the by-pass period, wherein the signals do not traverse the processor 3. Herein, the signals' levels are not being changed. Alternatively, a suitable gain can be provided to adjust those signals to a desired level, such as will be described below concerning FIG. 4.

Next, after the adjusting of the one or more signal processing parameters, the processor output 17 can again be faded-in to the at least one signal output 7. At the same time, the signal input 5 can be faded-out and decoupled from the signal output 7. Thereafter, the signal input 5 can still be coupled indirectly to the signal output 7 via the signal processor 3. Thus, subsequently, the adjusted or reprogrammed signal processor can again process the signals, received from the system input 5, wherein the processed signals can be fed to the output 7 of the system.

FIG. 3 shows a second embodiment. The second embodiment differs from the embodiment shown in FIG. 1, in that the second embodiment also includes a by-pass system 9, 11 as shown and described concerning in FIG. 2. This provides the advantages of the FIG. 2 embodiment to the embodiment of FIG. 1. The embodiment of FIG. 2 can also be provided with a mentioned processor adjusting system 8 (not depicted in FIG. 3), the adjusting system 8 being configured for adjusting the signal processor 3, for example to set one or more processor parameters.

Particularly, in FIG. 3, the controller 11 of the by-pass system is arranged between the first signal processor 3 and a subsequent signal processor, in the present case a mentioned Band-Splitter Filter 20.

In the FIG. 3 embodiment, the transition of sound signal processing parameters can be performed substantially in the following three steps, including a start of a processor adjusting phase (phase 1), a subsequent main adjusting phase (phase 2) and an end of the adjusting phase (phase 3). For example, in the following a fader of the controller 11 can fade between the processor output 17 and the signal input 5a during the mentioned by-pass period.

Phase 1) Starting a processor adjusting phase, the audio processing unit in transition (the first signal processor 3 for instance) is bypassed by the by-pass system 9, 11. In the embodiment of FIG. 3, to this aim, one microphone input 5a (say mic-1) is connected directly by-pass line 9 and controller 11 to an input of the Band-Splitter Filter 20. This is preferably not done abruptly, to prevent discontinuities that may cause clicks at the receiver 24 located downstream in the signal path. To this aim, the signal controller 11 can include one or more mentioned faders, which can smoothly fade out the original signal processor output 17 and fade in the mic-1 input 5a to the input of the Band-Splitter Filter 20.

For example, the output of the processing unit 3 to be programmed can be smoothly disconnected from the device's output port 7 by connecting the device's output port 7 to an unprocessed (or partially processed) input signal. This stage can be implemented using the fader over a short period of time (half a second for example, or a different period). The fading period is preferably chosen such that no artifacts are noticed during the redirection.

Phase 2) During the subsequent main adjusting phase, once the Beam Forming (BF) signal of the signal processor 3 is completely faded out, Beam Former coefficient switching can be safely done, preferably in one step, by overwriting the set of working coefficients in a memory M of the signal processor 3 by the new set of coefficients in one step. Since the Beam Former output 17 of the first signal processor 3 is not connected to the device output port 7 at this stage, the switching clicks will not be reproduced at the users' ear canals in case the user wears or carries the respective sound receiver 24.

During phase 2), for example, the system parameters under considerations are changed. Any artifacts introduced by this transition are preferably not noticeable by the user, since the output of the processing unit (processor 3) under programming is disconnected from the device output port 7.

Phase 3) The adjusting phase preferably ends immediately or swiftly after the step of writing the set of working coefficients to the memory M of the signal processor 3. Then, the BF processor output 17 signal (calculated using the new set of coefficients) is connected back to the input of the Band-Splitter Filter 20. This can be done gradually. Preferably, one or more faders of the controller 11 are employed to fade out the mic-1 signal of the input 5a, and to fade in the Beam Former output 17 signal.

Thus, for example, the output 17 of the processing unit 3 under programming can be smoothly reconnected to the device output port 7, completing the procedure. This stage can be implemented using the same or another fader over a short period of time (half a second for example). The fading period can again be chosen such, that no artifacts are noticed during the redirection.

For example, the fader object used in the present embodiment, i.e. a fader of the signal controller 11, can be a simple first order filter with two inputs and one output (i.e. an output of the signal controller 11), having the following time response when implemented as a discrete time object.

y[n]=x₂[n]*μ[n]+x₁[n]*(1−μ[n])

where n is the discrete sample index, μ[n] is the fader state, and in this example, x₁[n] is mic-1 signal of signal input 5a, x₂[n] is the output 17 of the first processor 3, and y[n] is the signal controller 11 output (mixed signal), and * indicates the multiplication operator and the + symbol indicated the addition operator. The respective signals x₁[n], x₂[n] and y[n] are indicated in FIG. 3.

In that case, for example, the first phase in the above procedure (the start of the processor adjusting phase) can be started by initializing the fader's μ variable to μ[0]=1.0; this results in y[n]=x₂[n] (the Beam Former output 17 is fully present at the Band Splitter Filter input). In subsequent sample periods, the fader μ[n] can simply be decreased by a constant step size until μ reaches 0, which can be used to signal the completion of the first phase. During the course of this update, y[n] consists of a smoothly changing mixture of the two signals x₁[n] and x₂[n]. At the beginning of the first phase y[n]=x₂[n], and at the end of this phase, y[n]=x₁[n].

For example, in the present embodiment, the step size of the fader μ can be calculated such that the first phase transition is completed in a specific pre-determined time interval. As an example only, for a time interval of 500 ms for the first phase, the fader step size FSS=1/(0.5×Fs), where Fs is the audio sampling rate.

After the completion of the first phase, the Beam Former processor 3 is completely bypassed by the by-pass system 9, 11, and any changes in its coefficients are not audible at the receiver 24. Therefore, the Beam Former processor coefficients can be switched in one step during the main adjustment phase, without fear of switching clicks.

Once the Beam Former processor 3 is re-initialized with the new set of coefficients, the Beam Former output can be gradually mixed back to the input of the Band-Splitter Filter. This can be done in phase three using a fader, exactly as in phase one, but now with x₁[n] as the Beam Former processor output 17 and x₂[n] as the mic-1 signal, received from one of the signal inputs 5a. At the beginning of phase 3), the fader μ can be re-initialized to μ[0]=1.0, resulting in y[n]=x₂[n] (Band-Splitter input is composed of 100% mic-1 signal, and 0% Beam Former signal). At the end of phase 3), the fader μ has been decreased gradually to 0 so that y[n] becomes y[n]=x₁[n] (Band-Splitter input is composed of 0% mic-1 signal, and 100% Beam Former signal).

The method described above is computationally very efficient. For example, in the present embodiment, the update equation can be performed once every frame of 16 samples and consumes only one addition, one subtraction, and two multiplications. In a further embodiment, some small extra overhead can be provided to implement the 3-phase procedure. The complete implementation is still very efficient in terms of the number of processor cycles consumed (a few cycles per frame, or a fraction of a cycle per sample), and therefore, can be successfully used in ultra low power applications and/or in applications employing limited computational capacity processor such as hearing aid units.

### EXPERIMENTAL RESULTS

Several simulations and experiments have been performed to test whether the above described procedure for switching coefficients, for example hearing aid coefficients, can actually results in substantially continuous audio signal with no audible artifacts. During those experiments, the Beam Former processor coefficients of a directional hearing aid device have been switched from a high directivity mode to the omni directional mode, at a specific time moment. The experiment is repeated with the angle of sound source (direction of arrival) changing from 0 (at the listener's side) to 90 degrees (in front of the listener).

With the above-described switching or by-pass procedure disabled, clear clicks have been noticed. This may be explained as follows. Since the directivity pattern of a high directivity mode of the system 1, when the sound is coming from the side of the microphone array 15, is low compared to the omni-directional case, a difference in signal level occurs when the switching is done, causing a short click. The amplitude of the resulting clicks depends only on the angle of arrival in this experiment, since all other parameters have been kept constant. In a commercial hearing aid product, the coefficients of other units (WDRC parameters for instance) are also updated at the same time, so in practice the switching artifacts will actually be much stronger than those encountered during the experiments.

The experiments mentioned above have been repeated with the switching procedure/by-pass method enabled, to examine the difference in the output signal. The switching procedure used in the experiments was completed in a time interval of only one second. Above-mentioned Phase 1) could be completed in half a second, followed by a very short phase 2), which is completed in one frame period of 16 samples at 16 kHz sample rate (1 ms), and finally the phase 3) was completed in another half a second. In all experiments, no switching artifacts have been noticed when the fader switching procedure was used. The switching procedure resulted in a smooth transition without interrupting the audio output, which is certainly preferred over muting the output during switching.

FIG. 4 shows another embodiment. The embodiment 1″ of FIG. 4 differs from the embodiment of FIG. 3, in that the by-pass system 9, 11 is configured to by-pass both the first signal processor 3, as well as some further signal processing units 120, 121, 123. Thus, the same parameter switching procedure presented above with respect to the FIG. 3 embodiment can also be used to mask the change in audio parameters of various system components 3, 20, 21, 23 simultaneously, such as shown in FIG. 4.

Besides, in a further aspect, shown in FIG. 4, the by-pass system can comprise an optional gain (or gain unit) 4 to adjust the level of the signals, which are fed from the signal input 5 to the signal output 7. Thus, during use, during a mentioned by-pass period, signals which are fed from the signal input 5 via the by-pass line 9 to the signal output 7 can be adjusted in level, for example to a desired level matching the level at the output port 7 before the parameter switching procedure. For example, to this aim, preferably, a gain factor of the system part to be by-passed is determined prior to starting the parameter switching procedure, wherein the determined gain factor (of the system part to be by-passed) can be copied to the gain block 4, to provide the matching of the levels.

Particularly, in the arrangement of FIG. 4, the system main output 7 can be mixed directly with a mic-1 signal, received from a signal input 5a via the by-pass line 9 and signal controller 11. Thus, in a mentioned first phase 1) most and preferably all adjustable audio processing units of the system 1″ can be by-passed.

Then, after the first phase, changes in any or all parameters in the whole audio chain of the system 1″ will not be audible at the system output (now the signal y[n]) 7. An advantage of this arrangement is, for example, that smoothing of WDRC 121 parameters can be avoided, since the new parameters can be copied in one step to overwrite the old ones during the mentioned main adjusting phase 2).

Besides, if desired, a microphone signal, provided at the signal input 5a, can be adjusted in level using gain 4 that can increase or decrease the signal level, for example fixed gain, by the gain 4. Preferably, the overall gain provided by the system 1″ prior to the parameter switching process is determined automatically first, for example by the by-pass system, wherein during a subsequent fading and/or decoupling process of a processed signal, this gain is applied to the microphone signal 5a by the gain 4, to avoid variations in signal strength at the system output 7.

In an aspect, the present invention can allow safe parameters switching, while avoiding the problems of muting. For example, as follows from the above, a following procedure can be used.

First, in an embodiment, a system processing block or unit in transition can be bypassed by smoothly fading a microphone signal to a device output 7. The fading time can be as short as e.g. half a second, or a different time period.

Secondly, in an embodiment, the parameters are switched from the old to the new setting. If clicks or spikes occur, the user does not hear them since the processing units are not connected to the device output at this stage

Thirdly, in an embodiment, the respective processing units' output is smoothly faded back to the device output. The fading time can be as short as e.g. half a second, or a different time period, completing the whole procedure swiftly.

In an aspect of the invention, using an above-described procedure, the sound output (for example at a system's main output 7) is preferably never discontinued while safely and quickly switching certain device parameters. In a hearing aid system, this allows the user of a hearing aid device to quickly decide whether the new hearing aid settings are better or worse than the previous setting, which improves the reliability of fitting sessions and makes the device user friendly during every day use. For example, the user can immediately hear the difference between subsequent parameter settings, and can judge which setting best fits his needs. In this way, a method has been proposed to perform the parameters switching while keeping control on the output audio signal quality at the hearing aid speaker. For example, the method can be or include a method for hearing aid parameters switching without discontinuing audio output during the switching.

Particularly, following from above-mentioned aspect of the invention, clicks, spikes, and uncontrolled output signals that might occur during parameters switching are no longer allowed to reach the user ears, therefore, protecting the user from further hearing damage. The user can continue to hear normally during programming (the device output is not muted). During fitting sessions, this improves fitting reliability since the user can immediately compare between the result of current and previous settings and direct the audiologist towards the best set of parameters. During normal operation, switching mode without muting the device output increases safety (in traffic for instance), and improves the device reaction to user requests.

Besides, in an embodiment, the invention can provide a method for parameter switching with smooth audio transition, comprising:

providing an audio source 15 and output 7;

providing an (unspecified) audio enhancement process, for example using one or more mentioned signal processors 3, the enhancement process being connected to the audio source 15;

providing a parameter configuration process, for example responsive to a user input (such as via a mentioned adjusting system 8), modifying parameters of the sound enhancement process (or one or more signal processors 3);

providing at least one fader (called signal controller 11 in the above), fading between the audio source 15 and enhanced audio; where

upon parameter modification request, for example according to user input, the fader 11 fades from the enhanced audio towards the audio source; and

after this is completed, the parameter modification is applied.

Preferably, when the parameter modification is complete (and transients are expected to have stabilized), the fader 11 fades from the audio source back towards the enhanced audio.

Also, in a further elaboration, the gain of the audio enhancement can be determined just before switching, wherein during the fading process, this gain is applied to the audio source

The invention can be applied, for example, in various types of hearing aid devices, and/or possibly other audio devices that may be insert able in the user's ear canals, where it is desired to change parameters—whether by an audiologist or by the user.

Although the illustrative embodiments of the present invention have been described in greater detail with reference to the accompanying drawings, it will be understood that the invention is not limited to those embodiments. Various changes or modifications may be effected by one skilled in the art without departing from the scope or the spirit of the invention as defined in the claims.

In the context of the present invention, the term “signal processor” should be interpreted broadly. For example, a signal processor can include an adjustable filter, micro-electronic circuit, electronic component such as a resistor, capacitor or inductor, a micro controller signal processor, digital signal processor, analogue signal processor, combinations of such adjustable signal processors and/or other types of adjustable signal processors. In the present patent application, signals, to be processed by a signal processor, are generally referred to as signals that relate to sound. For example, the signal processing system can be a sound signal processing system, wherein electric or electronic signals are being processed, the signals relating to sounds that can be detected by one or more suitable sound detectors.

For example, a mentioned signal, to be processed by a system or method according to the invention, can be an electric or electronic signal, optical signal, acoustic signal and/or an other signal. Also, the signal, to be processed, can be an electric or electronic signal, which is related to a different type of signal. For example, the signal, to be processed, can be an electric or electronic signal, which is related to sound and/or to video, wherein one or more sound and/or video detectors can be provided to generate such electric or electronic signals depending on detected sound and/or video.

As an example, in a hearing aid device or hearing aid method, the signals can be electric or electronic signals, preferably digital signals, generated by one or more mentioned sound detectors. As an example, a sound detector can comprise a suitable microphone, a sensitive low-noise microphone, transducer or different sound detector.

Also, the present invention can be implemented in hardware and/or software, as will be clear to the skilled person. For example, the invention can be provided in a computer program, which is provided with computer readable instructions, which instructions are configured to carry out a method according to the invention when the instructions are loaded in and run by a computer.

It is to be understood that in the present application, the term “comprising” does not exclude other elements or steps. Also, each of the terms “a” and “an” does not exclude a plurality. Also, a single processor or other unit may fulfill functions of several means recited in the claims. Any reference sign(s) in the claims shall not be construed as limiting the scope of the claims.

1. Signal processing system, comprising:
a signal input;
a signal output;
a signal processor configured to process signals received from the signal input and to feed the processed signals to the signal output via a processor output; and
a by-pass system configured to fade-out and/or decouple the processor output at least partly from the signal output and to couple and/or fade-in the signal input at least partly to the signal output during fading out and/or decoupling of the processor output.

2. System according to claim 1, wherein the by-pass system is configured to substantially fade-out the processor output during coupling and/or fading in of the signal input to the signal output.

3. System according to claim 1, wherein the by-pass system includes a gain to adjust signals which are fed from the signal input to the signal output, such that a signal strength at the system output is kept at substantially a constant signal level.

4. System according to claim 1, wherein the by-pass system includes at least one signal controller being arranged to control coupling of the processor output to the signal output and to control coupling of the signal input to the signal output.

5. System according to claim 4, wherein the signal controller includes a fader to fade-out the processor output.

6. System according to claim 5, wherein the fader is configured to fade-in the signal input directly into the signal output, during the fading-out of the processor output, to by-pass the processor.

7. System according to claim 4, wherein the by-pass system includes a signal by-pass line being arranged to couple the signal input to the signal controller the signal controller being arranged to control coupling and/or fading in of the by-pass line to the signal output.

8. System according to claim 1, wherein at least one signal processing parameter of the signal processor is adjustable, wherein the by-pass system is configured to fade-out and/or decouple the processor output at least partly from the signal output before the at least one signal processing parameter is adjusted, wherein the by-pass system is configured to couple and/or fade-in the processor output to the signal output after adjusting at least one signal processing paramenter.

9. System according to claim 1, wherein the by-pass system is controllable by a signal processor adjusting system being configured for adjusting the signal processor.

10. System according to claim 1, wherein the by-pass system is configured to fade-out and/or decouple the signal input from the signal output after the signal processor has been adjusted, wherein the by-pass system is configured to fade-in and/or couple the processor output to the signal output during fading out and/or decoupling of the signal input.

11. System according to claim 1, wherein the signal processor includes at least one of a microphone array beam former processor, a signal splitter, a compression unit and a signal combiner.

12. Signal processing method, comprising:
providing at least one signal input;
providing at least one signal output;
providing at least one adjustable signal processor, the signal processor being configured to process signals received from the input and to feed the processed signals to at least one processor output; wherein the at least one processor output is faded-out and/or decoupled at least partly from the at least one signal output during a by-pass period, wherein the at least one signal input is coupled and/or faded-in at least partly to the at least one signal output during the by-pass period.

13. Method according to claim 12, wherein the processor output is being substantially faded out and decoupled from the signal output during at least part of the by-pass period.

14. Method according to claim 12, wherein signals which are fed from the signal input to the signal output during the by-pass period are adjusted by a gain factor matching a gain factor of the at least one processor.

15. Method according to claim 12, wherein the signal input is faded-in directly into the signal output during fading out of the processor output.

16. Method according to claim 12, wherein signals from the signal input are fed directly to the signal output via a by-pass line during a processor adjusting phase of the by-pass period.

17. Method according to claim 12, wherein one or more signal processing parameters of the signal processor are adjusted during at least a part of the by-pass period when the at least one processor output has been faded-out and/or has been decoupled from the at least one signal output.

18. (canceled)

19. Method according to claim 17, wherein the one or more signal processing parameters include beam-forming coefficients.

20. Method according to claim 17, wherein all signal processing parameters of the signal processor (3) are being adjusted in one operation by writing one new set of parameters to a memory of the signal processor.

21. (canceled)

22. (canceled)
